(19) United States
(12) Patent Application Publication
(10) Pub. No.: US 2006/0041490 A1
(43) Pub. Date: Feb. 23, 2006

(54) Optimizing investment strategies for long/short fund portfolios

(76) Inventors: John A. Roberts, Congers, NY (US); Joel C. Hodes, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/920,779

(22) Filed: Aug. 18, 2004

(51) Int. Cl. G06Q 40/00

(52) U.S. Cl. 705/35

(57) ABSTRACT

Methods for optimizing a portfolio having at least a long position portion and a short position portion are disclosed. One exemplary method includes developing a portfolio optimization strategy for the portfolio including: adjusting at least one investment in the long position portion of the portfolio, wherein the adjusting includes adding at least one investment to the long position portion of the portfolio, and executing an optimizer methodology on the short position portion of the portfolio in association with at least the adjusting of the investments in the long position portion of the portfolio. The exemplary method further includes performing at least one transaction in accordance with the developed portfolio optimization strategy; generating a notional basket of investments including a plurality of investments selected from the short position portion of the portfolio; and, entering into at least one swap arrangement based on the generated basket of investments.

### BACKGROUND

In certain financial environments, tax considerations for investments may be important in view of prevailing laws, regulations, or rules that address taxation of income realized by various institutions or entities. Income derived from dividends on equity investments, for example, may be subject to taxation within a particular tax-affected financial environment.

It follows that investment institutions that pursue equity investments need to analyze the tax treatment of dividend income in association with balancing the costs and benefits of such investments. Investment institutions such as hedge funds that maintain both long-position investments and short-position investments within their portfolios, for example, need to manage costs and risks that may arise in connection with the tax consequences of dividend income arising from equity investments. However, various hedge funds may not employ effective financial tools or investment strategies that can be used to optimize an approach to achieving the financial objectives of the fund in view of adding certain investments (e.g., investments with a dividend yield) that may have tax consequences for the fund.

Therefore, for various institutions that hold equity investments, what are needed are effective investment strategies that can help to optimize portfolio composition, maximize investment performance and reduce investment costs.

### SUMMARY

Embodiments of the present invention may include a method for optimizing a portfolio having at least a long position portion and a short position portion. One exemplary method includes developing a portfolio optimization strategy for the portfolio including: adjusting at least one investment in the long position portion of the portfolio, wherein the adjusting includes adding at least one investment to the long position portion, and executing an optimizer methodology on the short position portion of the portfolio in association with at least the adjusting of the investments in the long position portion of the portfolio. This exemplary method further includes performing at least one transaction in accordance with the developed portfolio optimization strategy; generating a notional basket of investments including a plurality of investments selected from the short position portion of the portfolio; and, entering into at least one swap arrangement based on the generated basket of investments.

Another exemplary method for optimizing a portfolio involves developing a portfolio optimization strategy for the portfolio which includes: adjusting at least one investment in the short position portion of the portfolio, wherein the adjusting includes adding at least one investment to the short position portion, and executing an optimizer methodology on the long position portion of the portfolio in association with at least adjusting the investments in the short position portion of the portfolio. This exemplary method further includes performing at least one transaction in accordance with the developed portfolio optimization strategy; generating a notional basket of investments including a plurality of investments selected from the short position portion of the portfolio; and, entering into at least one swap arrangement based on the generated basket of investments.

Embodiments of the invention may further include one or more of the following features: entering into at least one swap arrangement based on at least one investment in the long position portion of the portfolio; executing the optimizer methodology in association with at least one investment goal of the fund; executing an optimizer methodology that includes executing an optimizer computer program; and/or generating an output for the optimizer methodology including at least a list of investments to be adjusted in the short position portion of the portfolio. In addition, the portfolio may include at least one hedge fund portfolio; at least one investment of at least one of the long position portion and the short position portion of the portfolio may include a dividend; and/or at least one investment of at least one of the long position portion and the short position portion of the portfolio may include an equity investment.

Embodiments of the present invention may also include system embodiments for optimizing a portfolio; computer-readable media embodiments including instructions for optimizing a portfolio; and/or, methods for arranging for optimizing a portfolio of a fund having at least a long position portion and a short position portion.

Other embodiments of the present invention will become apparent to those skilled in the art upon review of the following description and figures. It is intended that all such additional embodiments be within the scope of the present invention and be protected by the claims.

### BRIEF DESCRIPTION OF THE FIGURES

FIG. 1 includes a generalized schematic representation of an exemplary fund portfolio provided in accordance with embodiments of the present invention;

FIG. 2 includes a process flow diagram illustrating an exemplary method in accordance with various embodiments of the present invention;

FIG. 3 includes a schematic diagram illustrating various aspects of operational examples provided in accordance with embodiments of the present invention;

FIG. 4 includes a schematic diagram illustrating various aspects of operational examples provided in accordance with embodiments of the present invention;

FIG. 5 includes a schematic diagram illustrating various aspects of operational examples provided in accordance with embodiments of the present invention;

FIG. 6 includes a schematic diagram illustrating various aspects of operational examples provided in accordance with embodiments of the present invention;

FIG. 7 includes a schematic diagram illustrating various aspects of operational examples provided in accordance with embodiments of the present invention;

FIG. 8 includes a schematic diagram illustrating various aspects of operational examples provided in accordance with embodiments of the present invention; and,

FIG. 9 includes a schematic diagram illustrating various exemplary aspects of system embodiments provided in accordance with the present invention.

### DESCRIPTION

As employed in accordance with various embodiments of the present invention, the term “fund” includes any financial entity or institutional entity capable of managing, transacting, maintaining and/or performing investment related functions in association with a portfolio of the fund. One example of a “fund” that may be employed in accordance with embodiments of the present invention is a hedge fund. It can be appreciated, however, that other types of financial/institutional entities such as, for example and without limitation, mutual funds, family offices, separately managed accounts, limited partnerships, trusts, and/or other entities, institutions and/or accounts can be structured for application to the various embodiments of the present invention. In accordance with definitions provided below, a “fund” may possess one or more short positions and/or one or more long positions with respect to investments included within a portfolio of the fund. As applied to various embodiments herein, a suitable “fund” may include an institution/entity that is capable of employing one or more investment strategies including or more transactions that involve, for example and without limitation, selling short, leverage, program trading, swaps, arbitrage, and/or derivatives.

As used herein, a “long position” in a portfolio of a fund includes that state in which there is actual ownership of an investment such as, for example and without limitation, a security, contract, commodity, or other asset, liability or equity instrument included within, or associated with, the portfolio of the fund. In certain aspects of the present invention, a “long position” may include one or more “swap” arrangements (see below).

As used herein, a “short position” in a portfolio of a fund includes that state in which an investment such as, for example and without limitation, a security, contract, commodity, or other asset, liability or equity instrument included within, or associated with, the portfolio of the fund, has been sold without the fund having ownership of the investment. This may involve the fund borrowing from a lender (e.g., a broker) to facilitate the sale of the investment by the fund with the understanding that the borrowed security, contract, commodity, or other asset, liability or equity instrument is to be later repurchased by the fund and returned to the lender. In the context of stock, for example, the fund can sell shares of stock borrowed from a lender at the current market price. Thereafter, the fund can “cover” the short position of the fund with respect to the stock shares by buying back the sold shares. The fund can then return the borrowed stock shares to the lender. Profit (or loss) on the transaction for the fund can be calculated as the difference between the price at which the shares of stock were sold and the cost for the fund to repurchase the shares of stock, minus any applicable commissions and expenses for borrowing the stock from the lender. In certain aspects of the present invention, a “short position” may include one or more “swap” arrangements (see below).

As applied to various aspects of the present invention, a “swap” generally includes an exchange between parties of streams of economic benefits according to specified terms. The underlying (i.e., notional investment) for a swap can include, for example and without limitation, at least one of the following investments, either alone or in combination: one or more derivatives (e.g., options, futures, and the like); a basket including two or more investments; a basket option (in one aspect, an option on a basket of underlying equity related instruments, for example, or other instruments, selected for representation of an industry, economic sector, and/or other group); an equity basket option (in one aspect, an option on a portfolio comprising more than one stock or stock market index); and/or any group of instruments whose prices or rates can be used to create a composite instrument which can be traded as a unit, or which can serve as the underlying for practice of the present invention. For example, one type of swap is an “equity swap” which is an agreement between parties in which payment on at least one side of the agreement is linked to the performance of one or more equities or an equity index. In one aspect of an equity swap, the holder of a “long swap” receives the economic benefit (if any) of the appreciation and dividends of an underlying (notional) equity investment and is responsible for any depreciation of the underlying investment and a finance charge (e.g., LIBOR +/−a spread). The holder of a “short swap” for the equity investment receives the absolute value of any depreciation in the underlying (notional) equity investment plus a finance charge (e.g., LIBOR +/−a spread) and is responsible for payment of any appreciation in the underlying plus any dividends paid on the underlying.

In the context of long positions and short positions of a portfolio (as defined above), the terms “adjusting” or “adjustment” are applied herein are steps or actions planned prior to actual execution of a transaction that may include adding, removing, and/or modifying long position investments and/or short position investments of the portfolio.

As applied herein, the term “rules” includes, for example and without limitation, any laws, rules, regulations, and/or policies that may govern transactions undertaken by a fund, for example, or any other entities described herein. The various embodiments of the present invention are intended to comply with any applicable rules such as hedging rules, tax rules, and/or other rules. Any requirements described herein arising from specific rules are provided merely for purposes of illustration of the present invention. It will be appreciated that embodiments of the present invention may be modified, as may be necessary, to comply with applicable rules.

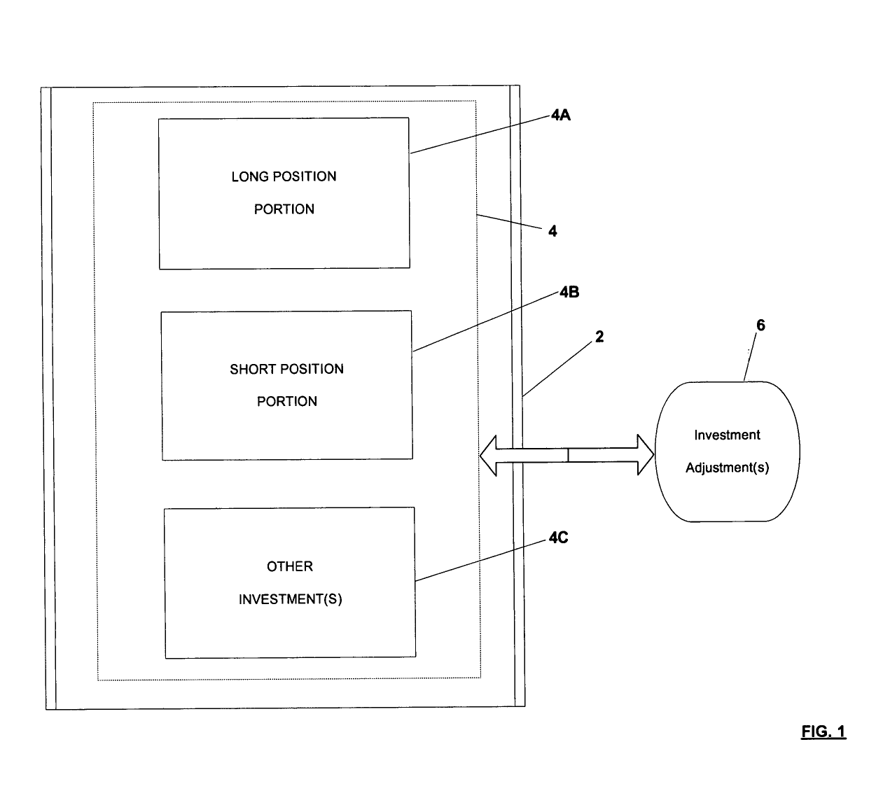

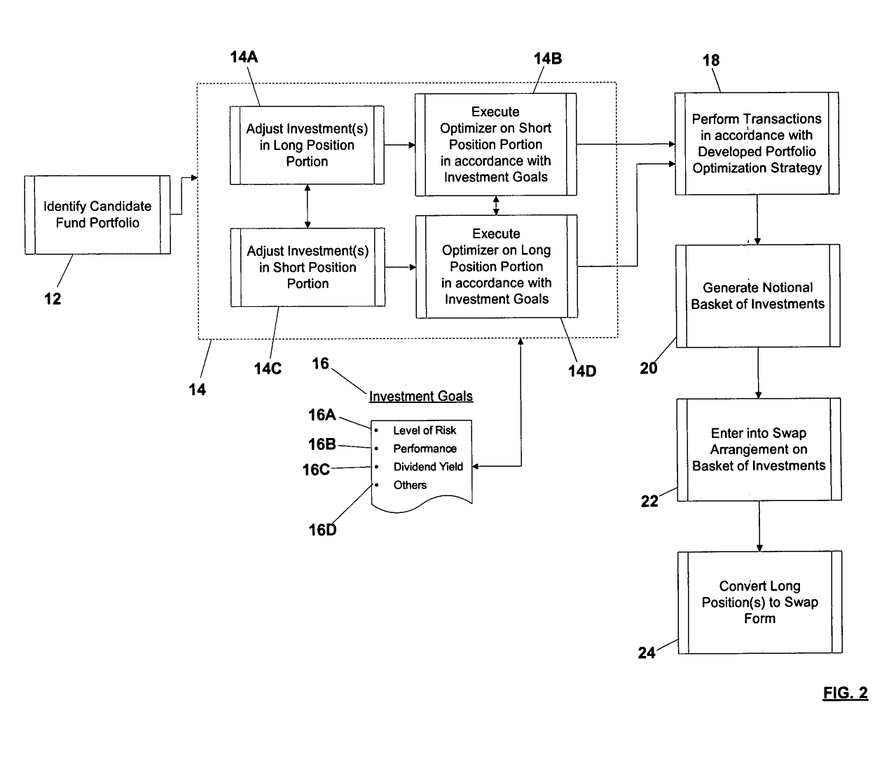

With reference to FIGS. 1 and 2, illustrative embodiments of the present invention are provided in association with a fund 2 having a portfolio 4. In step 12, an appropriate candidate fund portfolio, such as the portfolio 4 of the fund 2, may be identified. A suitable candidate fund includes, among other criteria, a combination of both long position investments and short position investments within the fund portfolio. It can be seen that the fund portfolio 4 maintains at least a portion of its investments in a long position portion 4A, which may include a number of swap arrangements associated with the investments in the portion 4A. In addition, the candidate fund portfolio 4 maintains at least a portion of its investments in a short position portion 4B, which may include a number of swap arrangements associated with the investments in the portion 4B. The portfolio 4 may also include one or more other portions such as portion 4C, which includes one or more other types of investments. As shown, the portfolio 4 is structured for one or more investment adjustments 6 that may be made in association with one or more of the portions 4A, 4B, 4C of the portfolio 4.

In step 14, an optimization strategy may be developed for the portfolio 4 in accordance with the present invention.

In step 14A, investments within the long position portion 4A of the fund portfolio 4 may be adjusted. Adjustments 6 that may be made include, for example, adding one or more supplemental investments, converting one or more long sales to swap form, or removing an investment from the portfolio 4. Supplemental investments may include at least one equity investment (e.g., common stock) which may have an associated income stream such as a dividend income stream, for example. It can be appreciated that the tax benefit of a supplemental investment having a dividend may be affected by rules relevant to tax treatment of such income streams. Adding supplemental investments with dividend income streams, for example, may benefit the fund portfolio 4 in the context of applicable rules that favor the tax treatment of dividend income in comparison to other types of income.

In step 14B, an optimizer methodology may be applied based on the adjustments 6 performed to the long position portion 4A in step 14A. The optimizer methodology may be executed in accordance with a variety of investment goals 16 that have been established for management of the portfolio 4. Examples of investment goals 16 include, without limitation, maintaining a level of risk 16A that is acceptable for investments included within the portfolio 4; enhancing investment performance 16B such as by selecting investments that may outperform other, alternative investments; selecting investments that include a dividend yield 16C that offers favorable tax consequences for the fund 2; and/or other investment goals 16D. The optimizer methodology executed in step 14B may be embodied as a computer program, for example, including software offered in association with the “Axioma” and “Barra” trade designations, or other conventional software designed for assisting with portfolio optimization. In addition, it can be appreciated that execution of the optimizer in step 14B may be embodied as a manual process undertaken by a manager of the fund 2, for example, who determines investment adjustments 6 to be made to the portfolio 4. Furthermore, a combination of both computer program execution and manual determination may also be conducted in step 14B within the scope of the present invention.

Likewise, in step 14C, investments within the short position portion 4B of the portfolio 4 may be adjusted. Adjustments 6 that may be made include, for example, adding one or more supplemental investments, converting one or more short sales to swap form, or removing an investment from the portfolio 4. Supplemental investments may include at least one equity investment (e.g., common stock) which may have an associated income stream such as a dividend income stream, for example.

In various embodiments of the present invention, at least part of the optimizer methodology undertaken in steps 14B, 14D may involve, for example, calculating a net standard deviation between the long position portion 4A and the short position portion 4B of the portfolio 4; maximizing an expected return on the difference between the long and short positions 4A, 4B; and/or another statistical analysis or calculation.

The output of the portfolio optimization strategy developed in step 14 may include a list of one or more adjustments 6 that may be made in accordance with the optimization strategy. In step 18, one or more transactions are executed in association with the adjustments 6 to the long position portion 4A and/or to the short position portion 4B of the portfolio 4, as may be applicable given the particular optimizer methodology undertaken in steps 14B, 14D. For example, the output of the optimizer execution of step 14B may include a list of short position 4B investments that are to be transformed from physical short sale form into swap form through transactions executed in step 18. The transactions of step 18 may also involve the purchase of stock investments, for example, for the long position portion 4A of the portfolio 4.

In step 20, a notional basket of investments can be generated based on investments included within the short position portion 4B of the portfolio 4. In step 22, a swap arrangement may be entered into by the fund 2 in connection with the swap basket generated in step 20. In various embodiments of the present invention, generating a swap on a basket of multiple equities may not give rise to application of certain rules or restrictions related to such transactions. For example, if the swap basket generated in step 20 includes twenty or more equities, and the investments in the swap basket are held at risk by the fund 2 for at least 60 days, the swap basket may be afforded favorable treatment in view of applicable hedging rules.

In various embodiments of the present invention, the candidate fund portfolio 4 may possess the ability to overlap its investments in the short position portion 4B with its investments in the long position portion 4A. For example, prior to development of the optimization strategy in step 14, there may be no equity investments overlapping between the short position portion 4B and the long position portion 4A of the fund portfolio 4. As applied herein, the term “overlap” means at least a partial coincidence of a particular kind or “name” of an investment (e.g., “IBM” stock), such as coincidence of investment names between the short position portion 4B and the long position portion 4A of the portfolio 4. Subject to applicable rules, there may be capacity in the portfolio 4 to add one or more supplemental investments to both the long position portion 4A and to the short position portion 4B of the portfolio 4. Adding the same kind of supplemental investment to both the long position portion 4A and the short position portion 4B may be possible up to an overlap limit of approximately 70 percent, for example, between the portions 4A, 4B. The overlapping investments may be stock investments which include a dividend, for example. Executing transactions that create an overlap condition for the portfolio 4 may result in minimizing the injection of risk into the portfolio 4, while not subjecting investments held within the portfolio 4 to applicable hedging rules, for example.

It can be seen that practice of the present invention includes the task of overall management and optimization of investments included within the long position portion 4A and the short position portion 4B of the portfolio 4 to maximize returns while minimizing risk. For example, adjustments 6 to the long position portion 4A of the portfolio 4 in step 14A, in addition to a basket swap on the short position portion 4B of the portfolio 4 in step 22, may result in minimizing risk while maximizing return on dividend income streams that offer favorable tax treatment for the fund 2.

In step 24, the fund 2 may perform one or more leverage transactions in connection with the long position portion 4A investments of the portfolio 4 to acquire additional resources to achieve an economic result for the fund 2. In various aspects, such leverage transactions may include one or more swap transactions, for example, and/or one or more other transactions that are derivative in nature. It can be appreciated that conversion of various investments in the short position portion 4B of the portfolio 4 in accordance with the optimization strategy developed in step 14 may impact the amount of cash available to the fund 2 to purchase investments for the long position portion 4A of the portfolio 4. Therefore, it may be desirable for the fund 2 in step 24 to convert one or more investments in the long position portion 4A of the portfolio 4 that are in physical long form, for example, into swap form to generate cash for the fund 2. It can be appreciated that the leverage transactions of step 24 may be performed at various stages throughout operation of the fund 2, such as prior to development of the optimization strategy in step 14, for example.

### OPERATIONAL EXAMPLES

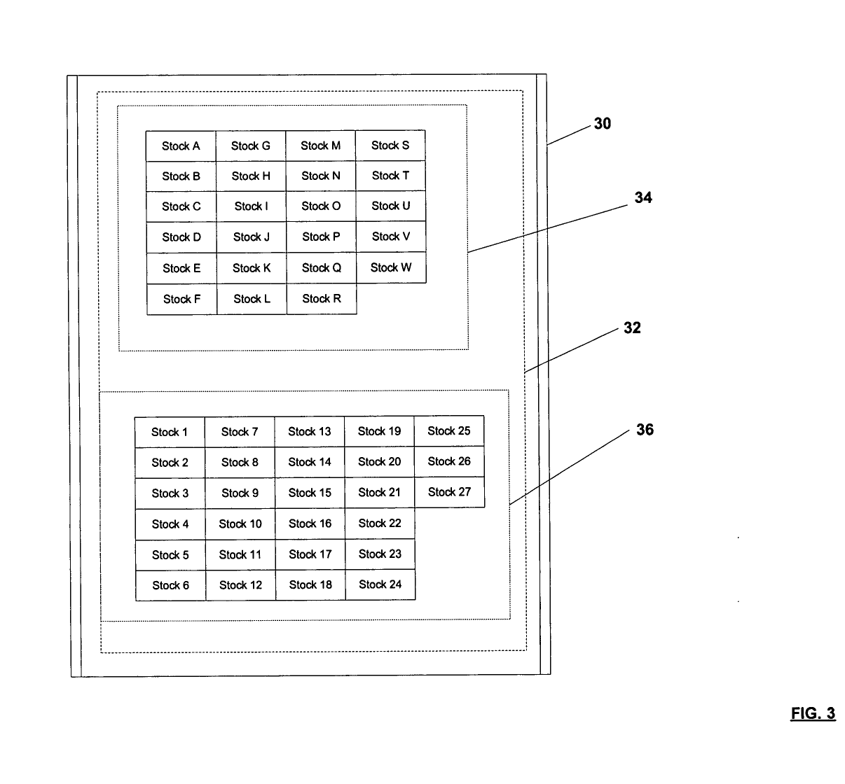

Referring now to FIGS. 3 through 8, various operational examples are provided to illustrate various aspects of the present invention for those skilled in the art. No particular aspect of these operational examples is intended to limit the scope of the present invention. The choice of nomenclature for naming/numbering of stocks, for example, is merely for convenience of disclosure, any similarity of names/numbers of investments to actual stock investments is coincidental.

As shown in FIG. 3, an exemplary hedge fund 30 portfolio 32 includes a long position portion 34 and a short position portion 36. The long position portion 34 includes multiple equity related investments (indicated by names A-W), wherein investments A-E are stocks in swap form, investments F-O are stocks that do not have a dividend yield, and investments P-W are stocks that have an associated dividend yield. The short position portion 36 includes multiple equity related investments (indicated by numbers 1-27), wherein investments 1-24 are physical short sales of stock, and investments 25-27 are stocks in swap form. It can be seen that the portfolio 32 may be identified in accordance with step 12 as a suitable candidate fund portfolio.

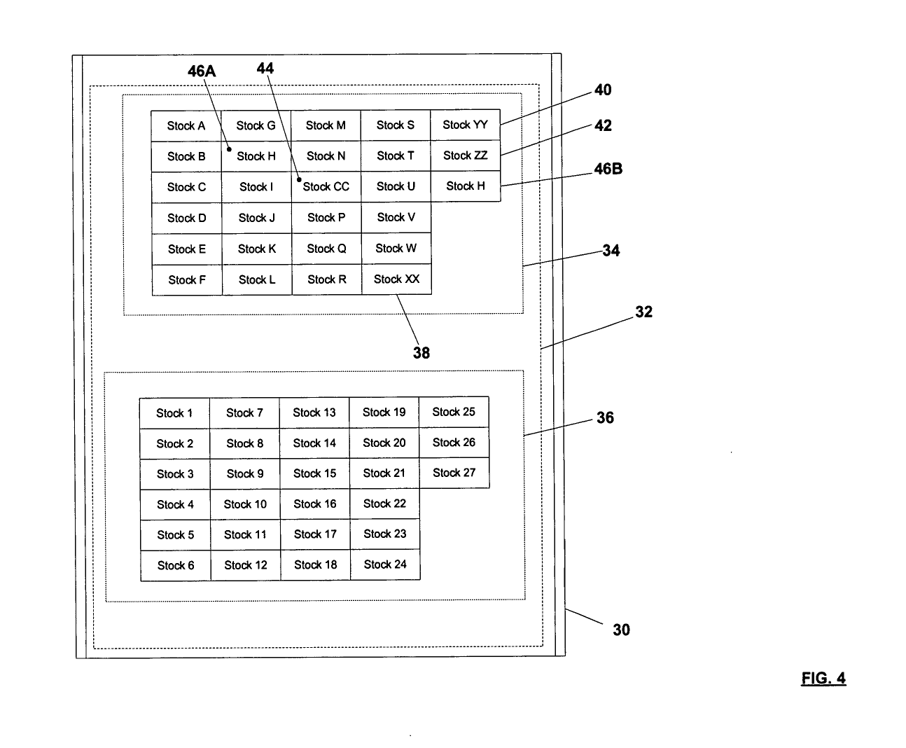

Referring now to FIG. 4, and in accordance with step 14, a portfolio optimization strategy is developed for the fund portfolio 32. The portfolio optimization strategy involves making one or more investment adjustments 6 to the long position portion 34 of the fund portfolio 32 in step 14A. As shown, the long position portion 34 is adjusted with the addition of stock XX (38), stock YY (40), and stock ZZ (42); stock O (shown as removed), which is a non-dividend yielding investment, is replaced by stock CC (44), which is a dividend-yielding investment; and, an additional quantity 46B of stock H (46A) is added to the long position portion 34.

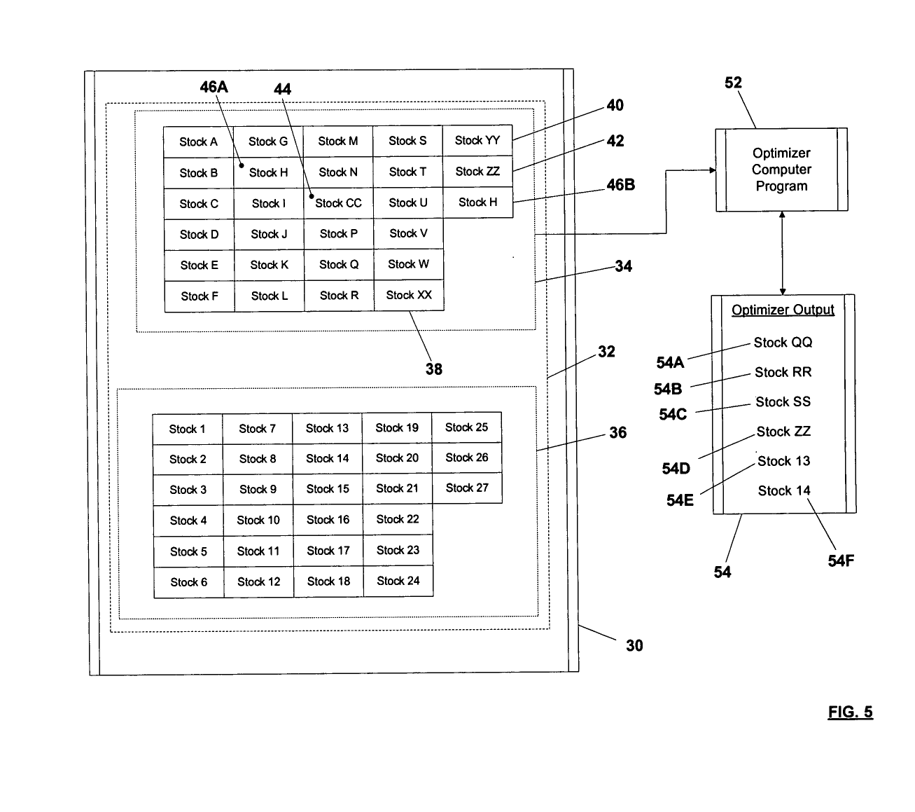

Referring now to FIG. 5, and in accordance with step 14B, an optimizer computer program 52 is executed that takes into account at least one of the investment goals 16 for the portfolio 32 and the investment adjustments 6 made to the long position portion 34 of the portfolio 32 (in accordance with step 14A-see above). An output 54 resulting from execution of the optimizer computer program 52 includes a list of investments that may be used in association with making one or more investment adjustments 6 to the short position portion 36 of the portfolio 32. In the present example, the output 54 displays a list including recommendations to establish physical short sale positions for stock QQ (54A), stock RR (54B), stock SS (54C), and stock ZZ (54D). The output 54 listing further includes recommendations to add two stocks that are already held within the short position portion 36 of the portfolio 32 (i.e., stock 13 (54E) and stock 14 (54F)).

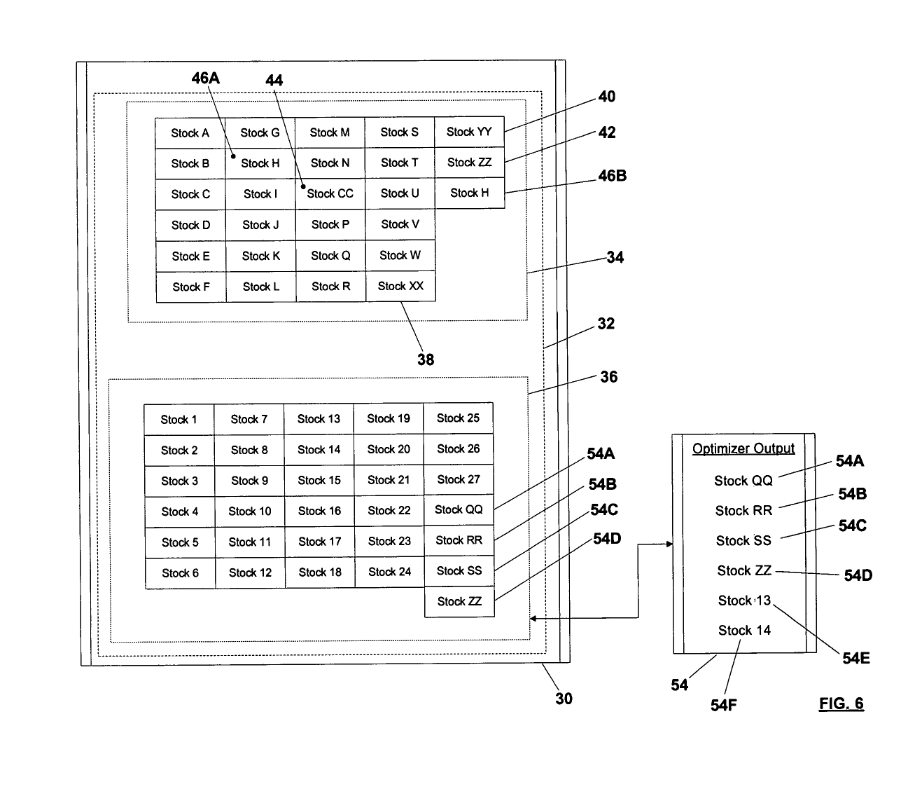

Referring now to FIG. 6, the output 54 of the optimizer computer program 52 may be translated into various transactions that are executed in step 18 to implement the portfolio optimization strategy developed in step 14. For example, stock QQ (54A), stock RR (54B), stock SS (54C) and stock ZZ (54D) may be sold by the hedge fund 30 as physical short sale transactions executed in accordance with the output 54 listing. In addition, the investment adjustments 6 planned for the long position portion 34 in step 14A may now be executed in accordance with step 18. For example, the hedge fund 30 may purchase shares of stock XX (38), stock YY (40), stock ZZ (42) and stock H (46B) and hold these stocks 38, 40, 42, 46B as investments in the long position portion 34 of the portfolio 32. It can be seen that the presence of stock ZZ (42) in both the long position portion 34 and stock ZZ (54D) in the short position portion 36 creates an overlap condition for the portfolio 32 of the hedge fund 30.

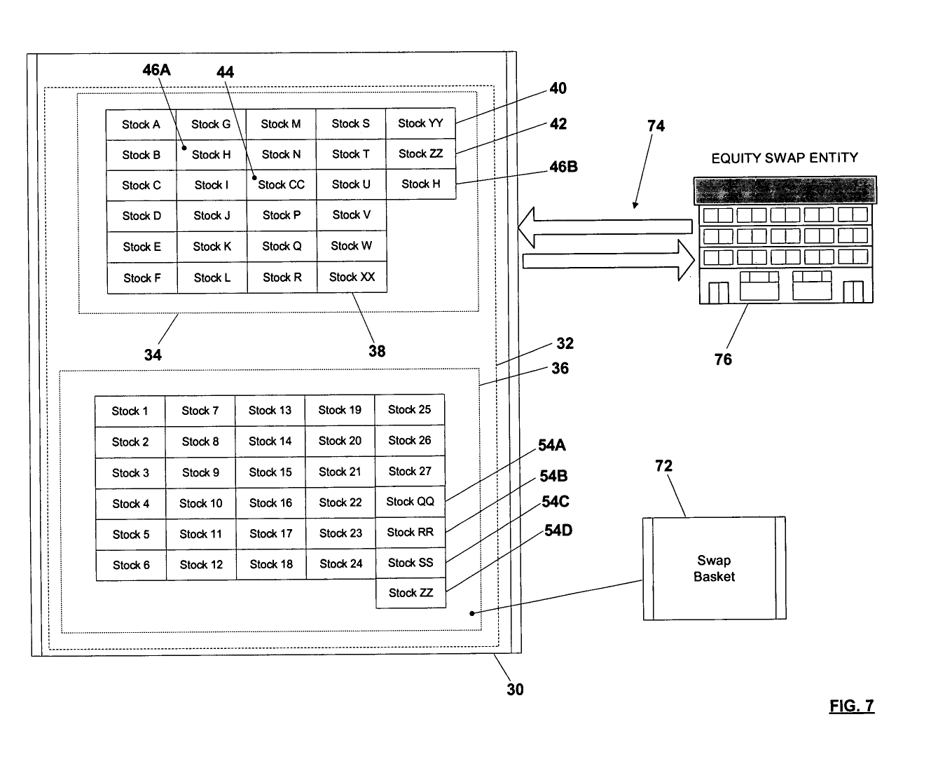

Referring now to FIG. 7, a notional swap basket 72 may be generated in step 20 in association with the stock investments included within the short portion position 36 of the portfolio 32. The swap basket 72 enables one or more swap arrangements 74 to be entered into by the hedge fund 30 with an equity swap entity 76. As applied to various embodiments of the present invention, the equity swap entity 76 may include any financial, institutional and/or corporate entity capable of entering into swap arrangements 74 with the hedge fund 30. Subject to applicable rules, the swap basket 72 generated in step 20 may include at least a plurality of, or all of, the investments in the short position portion 36 of the portfolio 32, including the stocks added in step 18 as a result of the investment adjustments 6 recommended by the optimizer computer program 52 in step 14B. In the present example, the generated swap basket 72 includes swaps for all stock investments held by the hedge fund 30 within the short position portion 36 of the portfolio 32.

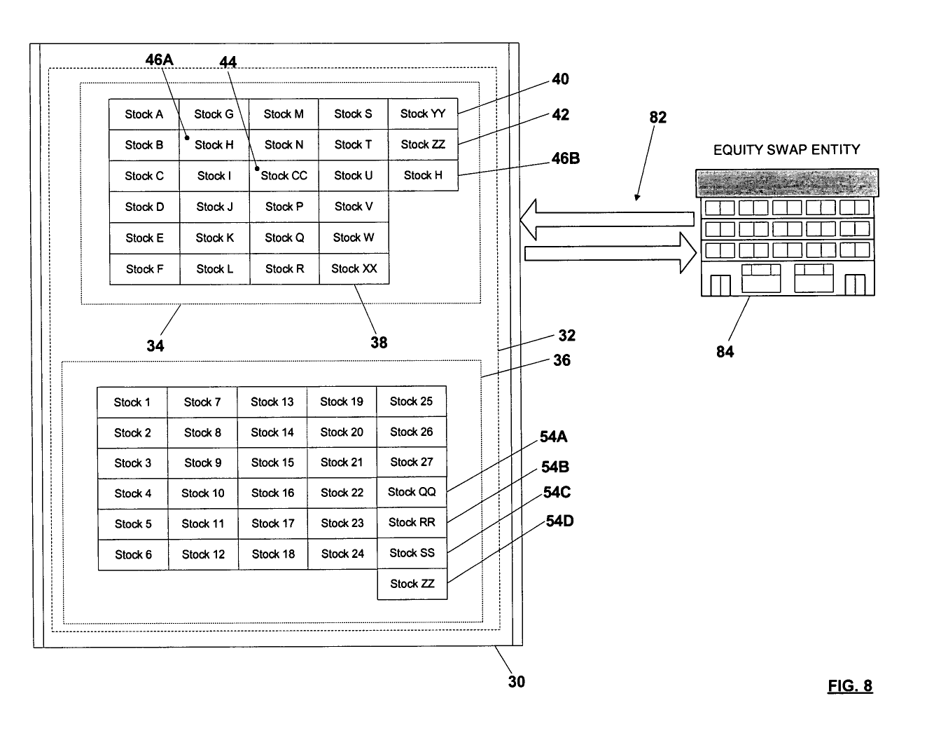

As illustrated in FIG. 8, one or more swap arrangements 82 may be entered into in association with the long position portion 34 of the fund portfolio 32. These swap arrangements 82 may be entered into by the hedge fund 30 with an equity swap entity 84. As applied to various embodiments of the present invention, the equity swap entity 84 may include any financial, institutional and/or corporate entity capable of entering into a swap arrangement with the hedge fund 30. It can be appreciated that the swap arrangements 82, which are based on the long position portion 34 of the portfolio 32, may provide additional leverage to the hedge fund 30 in the form of cash received by the hedge fund 30 for converting long positions into swap form. For example, stock XX (38), stock YY (40), and stock ZZ (42) added to the long position portion 34 of the portfolio 32 may be converted from being held as physical long positions into swap form. It can be seen that this conversion involves the sale of long position stocks that provides the hedge fund 30 with cash or other consideration that may be used for conducting various investment transactions or other operations.

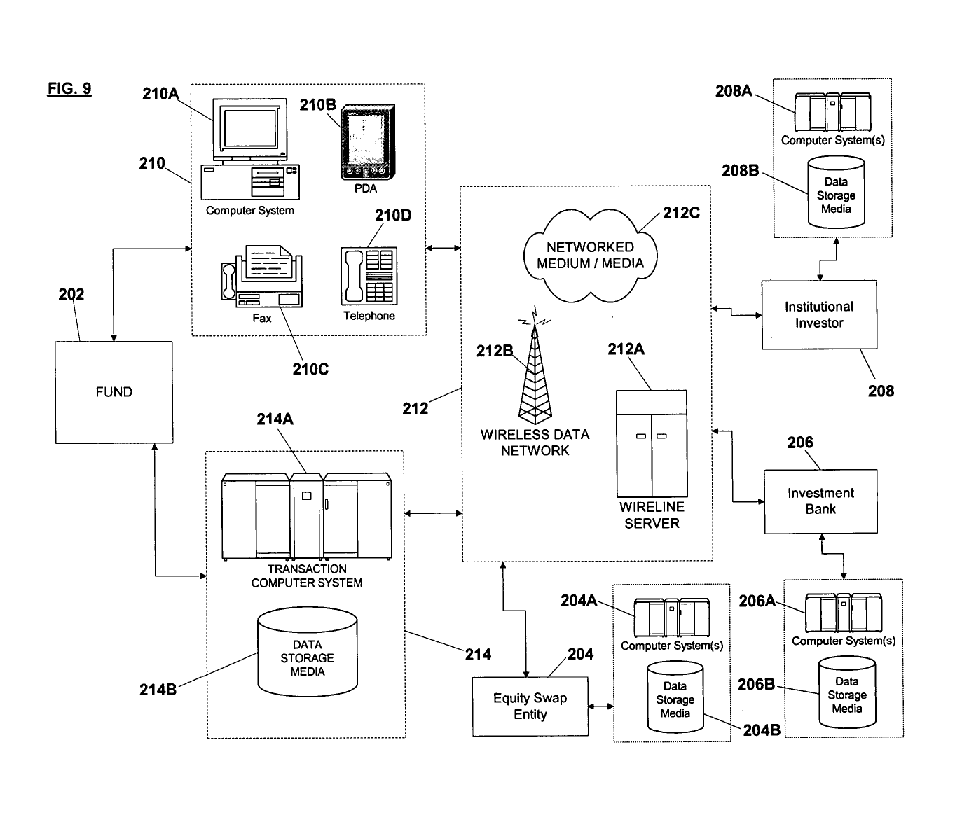

Referring now to FIG. 9, exemplary system embodiments are provided in accordance with the present invention. As shown, a fund 202 may communicate and/or exchange data with one or more of an equity swap entity 204, an investment bank 206, and/or an institutional investor 208. The fund 202 may be operatively associated with one or more communications devices 210 such as, for example and without limitation, a computer system 210A, a personal digital assistant 210B, a fax machine 210C, and/or a telephone 210D (e.g., a wireline telephone, a wireless telephone, a pager, and the like), and/or other like communication devices. The communication devices 210 permit the fund 202, the equity swap entity 204, the investment bank 206, and/or the institutional investor 208 to communicate between/among each other through one or more communication media 212, such as by use of electronic mail communication or through one or more computer systems, for example. The communication media 212 may include, for example and without limitation, wireline communication means such as a wireline server 212A, a wireless data network 212B, and/or a connection through a networked medium or media 212C (e.g., the Internet).

In various embodiments of the invention, the fund 202, as well as any one or more of the equity swap entity 204, the investment bank 206, and/or the institutional investor 208, may be operatively associated with one or more data processing/storage devices 214. As shown in FIG. 9, the fund 202 may be operatively associated with a transaction computer system 214A, for example, and/or one or more data storage media 214B that can be configured to receive, store, analyze and/or otherwise process data or other information in association with communications that occur between/among the fund 202, the equity swap entity 204, the investment bank 206, and/or the institutional investor 208. In addition, the equity swap entity 204 may be operatively associated with one or more computer systems 204A and/or one or more data storage media 204B. The investment bank 206 may be operatively associated with one or more computer systems 206A and/or one or more data storage media 206B. For example, the investment bank 206 may employ a computer program optimizer (e.g., the optimizer 52 or other computer-based optimizer embodiments described herein) in connection with assisting the fund 202 to plan or execute transactions in accordance with the present invention. Also, the institutional investor 208 may be operatively associated with one or more computer systems 208A and/or one or more data storage media 208B. It can be appreciated that the computer systems 204A, 206A, 208A, 214A and the data storage media 204B, 206B, 208B, 214B may be employed to communicate, store, analyze, and/or otherwise process data related to financial or investment transactions conducted between/among the fund 202, the equity swap entity 204, the investment bank 206, and/or the institutional investor 208.

In various embodiments of the invention, the investment bank 206 may perform a variety of functions for various entities associated with practice of the present invention. In certain embodiments, the investment bank 206 may assist in identification of a suitable candidate fund portfolio (see step 12). The investment bank 206 may assist the fund 202 with adjusting investments, for example, in the long position and/or short position portions of the fund 202 portfolio (see steps 14A, 14C). In addition, the investment bank 206 may assist the fund with execution of an optimizer methodology in accordance with steps 14B, 14D including, for example, structuring a notional basket of investments for the fund 202. Also, the investment bank 206 may arrange for execution of one or more transactions (e.g., stock sales or purchases in accordance with step 18) in association with developing or executing a portfolio optimization strategy. The investment bank 206 may also structure or arrange various aspects of swap arrangements between the fund 202 and the equity swap entity 204, for example.

The benefits of the various embodiments of the present invention are readily apparent to those skilled in the art. Embodiments of the invention may provide enhanced returns, while minimizing risk, in connection with investment strategies for fund portfolios that have at least a combination of long position investments and short position investments. Through practice of the present invention, funds such as hedge funds may improve their ability to manage risks associated with the long positions and short positions of their portfolios, while maximizing benefits garnered from favorable tax treatment of certain dividend yielding investments.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, optical disk drives, and hard disk drives; memory storage that can be physical, virtual, permanent, temporary, semi-permanent and/or semi-temporary; and/or, one or more data signals transmitted on one or more carrier waves.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. No particular aspect of the examples is intended to limit the scope of the present invention.

It should be appreciated that all the figures are presented for illustrative purposes and not as construction drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the following claims.

What is claimed is:

1. A method for optimizing a portfolio having at least a long position portion and a short position portion, the method comprising:
developing a portfolio optimization strategy for the portfolio including:
adjusting at least one investment in the long position portion of the portfolio, wherein the adjusting includes adding at least one investment to the long position portion of the portfolio,
executing an optimizer methodology on the short position portion of the portfolio in association with at least the adjusting of the investments in the long position portion of the portfolio;
performing at least one transaction in accordance with the developed portfolio optimization strategy;
generating a notional basket of investments including a plurality of investments selected from the short position portion of the portfolio; and,
entering into at least one swap arrangement based on the generated basket of investments.

2. The method of claim 1, further comprising entering into at least one swap arrangement based on at least one investment in the long position portion of the portfolio.

3. The method of claim 1, wherein executing an optimizer methodology further includes executing an optimizer methodology in association with at least one investment goal of the fund.

4. The method of claim 1, wherein the portfolio includes at least one hedge fund portfolio.

5. The method of claim 1, wherein executing an optimizer methodology includes executing an optimizer computer program.

6. The method of claim 1, wherein at least one investment of at least one of the long position portion and the short position portion of the portfolio includes a dividend.

7. The method of claim 1, wherein at least one investment of at least one of the long position portion and the short position portion of the portfolio comprises an equity investment.

8. The method of claim 1, wherein developing a portfolio optimization strategy further includes generating an output of the executed optimizer methodology, the output including at least a list of investments to be adjusted in the short position portion of the portfolio.

9. A method for optimizing a portfolio having at least a long position portion and a short position portion, the method comprising:
developing a portfolio optimization strategy for the portfolio including:
adjusting at least one investment in the short position portion of the portfolio, wherein the adjusting includes adding at least one investment to the short position portion of the portfolio,
executing an optimizer methodology on the long position portion of the portfolio in association with at least the adjusting of the investments in the short position portion of the portfolio;
performing at least one transaction in accordance with the developed portfolio optimization strategy;
generating a notional basket of investments including a plurality of investments selected from the short position portion of the portfolio; and,
entering into at least one swap arrangement based on the generated basket of investments.

10. The method of claim 9, further comprising entering into at least one swap arrangement based on at least one investment in the long position portion of the portfolio.

11. The method of claim 9, wherein executing an optimizer methodology further includes executing an optimizer methodology in association with at least one investment goal of the fund.

12. The method of claim 9, wherein the portfolio includes at least one hedge fund portfolio.

13. The method of claim 9, wherein executing an optimizer methodology includes executing an optimizer computer program.

14. The method of claim 9, wherein at least one investment of at least one of the long position portion and the short position portion of the portfolio includes a dividend.

15. The method of claim 9, wherein at least one investment of at least one of the long position portion and the short position portion of the portfolio includes an equity investment.

16. The method of claim 9, wherein developing a portfolio optimization strategy further includes generating an output of the executed optimizer methodology, the output including at least a list of investments to be adjusted in the long position portion of the portfolio.

17. A method for arranging for optimizing a portfolio of a fund having at least a long position portion and a short position portion, the method comprising:
developing a portfolio optimization strategy for the fund portfolio including:
adjusting at least one investment in the long position portion of the portfolio, wherein the adjusting includes adding at least one investment to the long position portion of the portfolio,
executing an optimizer methodology on the short position portion of the portfolio in association with at least the adjusting of the investments in the long position portion of the portfolio;
arranging for performance of at least one transaction in accordance with the developed portfolio optimization strategy;
structuring a notional basket of investments for the fund including a plurality of investments selected from the short position portion of the portfolio; and,
arranging for the fund to enter into at least one swap arrangement based on the generated basket of investments.

18. The method of claim 17, further comprising arranging for the fund to enter into at least one swap arrangement based on at least one investment in the long position portion of the portfolio.

19. A method for arranging for optimizing a portfolio of a fund having at least a long position portion and a short position portion, the method comprising:
developing a portfolio optimization strategy for the fund portfolio including:
adjusting at least one investment in the short position portion of the portfolio, wherein the adjusting includes adding at least one investment to the short position portion of the portfolio,
executing an optimizer methodology on the long position portion of the portfolio in association with at least the adjusting of the investments in the short position portion of the portfolio;
arranging for performance of at least one transaction in accordance with the developed portfolio optimization strategy;
structuring a notional basket of investments for the fund including a plurality of investments selected from the short position portion of the portfolio; and,
arranging for the fund to enter into at least one swap arrangement based on the generated basket of investments.

20. The method of claim 19, further comprising arranging for the fund to enter into at least one swap arrangement based on at least one investment in the long position portion of the portfolio.
